(19) United States
(12) Patent Application Publication
(10) Pub. No.: US 2025/0170567 A1
(43) Pub. Date: May 29, 2025

(54) DEVICE FOR DOSING A LIQUID, AND METHOD OF USE

(71) Applicant: Technische Universiteit Delft, Delft (NL)

(72) Inventors: Murali Krishna GHATKESAR, Delft (NL); Maarten BLANKESPOOR, Delft (NL); Tomas MANZANEQUE GARCIA, Delft (NL)

(21) Appl. No.: 18/841,166

(22) PCT Filed: Feb. 22, 2023
(86) PCT No.: PCT/EP2023/054433

§ 371 Date: Aug. 23, 2024

(30) Foreign Application Priority Data
Feb. 23, 2022 (NL) 2031047

(51) Int. Cl. B01L 3/02

(52) U.S. Cl. CPC B01L 3/022; B01L 2300/0877; B01L 2400/0406

(57) ABSTRACT

The invention provides devices and methods for dosing a liquid. A channel which ends in an opening of the device, for aspiration and/or dispension of a portion of the liquid through the opening and into the channel in an axial direction is configured for capillary flow of the liquid portion therethrough. The channel is formed along at least a part of its axial extension by a continuous array of, fixed-volume, advancement portions and pinning portions. At an axial boundary between each advancement portion and a respective pinning portion thereof which succeeds the advancement portion in the axial direction a phase guide is formed along an entire circumference of the channel, such that upon advancement of the liquid portion through the channel in the axial direction by capillary flow, a meniscus of the liquid portion at a downstream end of the liquid portion is pinned at the respective axial boundary.

### TECHNICAL FIELD

The invention relates to the field of microfluidics, which deals with fluid flow in channels which typically have a diameter in the range of microns. In particular, the invention relates to dosage of a liquid in volumes at the microscale, in particular in the range below nanolitres. Microscale liquid dosing is used for example in single-cell analysis, wherein content from single living cells is analyzed for advanced research purposes. This involves injection and aspiration of this content with high precision. Further applications are seen in pharmaceutics testing, and microchemistry, in particular in dosage of reagents.

### DESCRIPTION OF RELATED ART

At the microscale, fluid flow through channels is controlled generally by means of pressure control. Therein, the precision of the control depends on the properties of the fluid, the dimensions of the channel, the magnitude of the applied pressure, and the duration of the applied pressure. As the scale decreases, the influence of surface tension effects and uncertainties in the fluidic resistance increases—which may complicate the control of the flow, e.g. hampering the achievement of the desired or required precision in the envisaged application.

Accurate control of fluid flow is essential in the dosage of fluids, especially at the microscale. In fluid dosing at the microscale, it is known to use a microfluidic device capable of aspirating and/or dispensing determined volumes of fluid. For example, a microfluidic device is used to aspirate a fluid at a determined precise volume, e.g. in order to take a sample, e.g. from a living cell, a pharmaceutic component, or reagent, for example to subsequently be dispensed by the device and analyzed, e.g. under a microscope, or for example to be mixed with a determined precise amount of another component. A known microfluidic device is a micropipette, having a channel with at one end thereof an opening through which the fluid is exchanged with the environment. A common method for effectuating the exchange of the fluid with the environment, is to apply, at the other end of the channel, and thus of any aspirated fluid in the channel, a controlled pressure regulating the flow of the fluid through the opening and the channel itself. Aspiration and dispension are respectively achieved by applying an underpressure and overpressure in the channel. Alternative methods are available in the form of thermal or electrochemical actuation, however, entail a limitation on the range of fluids for which these are effective. Pressure control is therefore preferred over these alternatives.

Pressure control has, in particular when applied as the only measure for control of fluid dosing at the microscale, however turned out to be unsatisfactory in achieving sufficiently accurate dosage of volumes in some applications.

### SUMMARY OF THE INVENTION

It is an object of the present invention to provide at least an alternative form of pressure control of liquid dosing at the microscale. It is a further object of the present invention to provide control of liquid dosing at the microscale with which higher accuracies may be achieved. It is a further object of the present invention to provide control of liquid dosing at the microscale with higher efficiency and/or effectiveness.

The invention provides devices for dosing a liquid. Dosage may be achieved through volume control of the aspiration of a liquid portion into the device and/or of the dispension of a liquid portion from the device. In a use of the device, a liquid portion may be accurately dosed by means of the aspiration and subsequently be dispensed in its entirety at the site where it is needed, e.g. for analysis, to achieve that the aspirated and subsequently dispensed liquid portion as a whole has a predetermined volume.

The device according to the present application provides measures for providing volume control by means of particularly the aspiration of the liquid. The device according to the present application provides measures for providing volume control by means of both aspiration and dispension of the liquid. The device according to the present application provides measures for providing volume control by means of particularly the aspiration of the liquid.

The device according to the present application comprises a channel which ends in an opening of the device, for aspiration and/or dispensation of a portion of the liquid through the opening, respectively into and/or out of the channel in an axial aspiration direction and/or dispension direction.

The channel is configured for capillary flow of the liquid portion therethrough. The configuration of the channel for capillary flow, e.g. the dimensioning thereof and the material of the inner surface thereof that forms the interface with the liquid, may e.g. depend on the properties of the liquid to be used. As is known in the art, at this interface, the surface is preferably hydrophilic in order for the liquid to advance by capillary action whenever the contact angle with the surface is less than 90°—i.e. when the meniscus at the downstream end of the liquid portion is concave. Alternatively, the surface is hydrophobic.

According to the invention, the channel of the device according to the present application is formed along at least a part of its axial extension by a continuous array of, fixed-volume, advancement portions and pinning portions. Each of the channel portions has a respective wall with a hydrophilic internal surface enclosing an internal volume of the channel portion. The array of channel portions is formed such, that at an axial boundary between each advancement portion of the array and a respective pinning portion thereof which succeeds the advancement portion in the relevant advancement direction, i.e. the aspiration direction and/or the dispension direction, a shoulder is formed along substantially the entire circumference of the channel by a wall of the pinning portion flaring radially outwardly from a wall of the advancement portion at the axial boundary, at an angle with the advancement portion wall, seen in a diametrical cross-section of the channel. The form is such that upon advancement of the liquid portion through the channel in the relevant axial direction by capillary action, the liquid portion encounters an expansion of the channel at the shoulder at each axial boundary encountered by a downstream and/or upstream end of the liquid portion, a meniscus of the liquid portion at a that end of the liquid portion thereby being pinned at the respective axial boundary. With this configuration, the multiple, axially spaced shoulders form a set of phase guides which each extend over the entire tangential circumference of the channel at the locations of the axial boundaries, and thus, over the entire tangential circumference of the flow.

The phenomenon of meniscus pinning by the use of phase guides as such, is known in the art, and its use in microscale channels for liquids is known from e.g. WO2010086179 and WO2014038943. In these disclosures, meniscus pinning is achieved by applying 2D- or 3D phase guides in fluid systems, with the purpose of aligning an advancing phase front. Therein a phase guide is applied for example at a determined radial location or stretch at the circumference of the channel, so that an advancing phase front is pinned at that location or stretch, for example in a particular shape. The local pinning pulls the phase front from that pinning into a particular shape as the phase front advances further in the non-pinned radial stretch thereof.

The insight that meniscus pinning can be used for controlling the advancement of a phase front through a channel in discrete steps, when it is, firstly, realized over the entire circumference of the flow, i.e., the entire tangential extension, and secondly, realized in this form at multiple axially spaced locations along the flow direction, is employed in the device disclosed in WO01/85342 in relation to the embodiment in FIG. 2, which is according to the present application.

The first condition, pinning over the entire circumference of the flow, is found to cause the meniscus to change from a concave shape to a convex shape, and be completely stopped from advancement through the channel, as the capillary pressure becomes larger than the propelling action of the liquid by the capillary effect. Further advancement of the circumferentially pinned and completely stopped meniscus involves overcoming a burst pressure, which results from the capillary pressure as dependent on at least the contact angle and surface tension of the meniscus and channel diameter.

The second condition, applying multiple phase guides at mutual distances along the flow direction, then enables to control whether the stopped phase front of the liquid advances, by capillary flow, from one phase guide to a consequent downstream phase guide or not, by controlling whether the burst pressure is applied or not when the meniscus is pinned at the phase guide. With multiple phase guides placed consecutively along the flow direction, it is possible to control up to which of the phase guides the phase front of the liquid advances by controlling the application of the burst pressure upon the pinning of the meniscus at the phase guides upstream thereof.

In the device according to the present application and disclosed by WO0185342, the phase guides are provided in the form of the shoulders at the axial boundaries over the entire flow circumference, which results in an expansion of the flow channel being encountered by the meniscus causing it to change from the concave shape to a convex shape, and be completely stopped from further advancement through the channel. Seen in the aspiration and/or dispension direction, an expansion of the channel is thus formed at the shoulder at each axial boundary for at this axial boundary pinning of the meniscus of the liquid portion being displaced in the respective direction. The effect is that upon advancement of the liquid portion through the channel in the axial aspiration direction by capillary flow, the liquid portion encounters an expansion of the channel at the shoulder at each axial boundary encountered by a downstream end and/or an upstream end of the liquid portion, a meniscus of the liquid portion at the respective end thereby being pinned at the respective axial boundary, the capillary flow thereby being stopped.

The devices according to the present application enables to achieve dosing of liquid by means of aspiration and dispension respectively, as a liquid portion contained in the channel is during aspiration resp. dispension thereof stopped at the phase guides by meniscus pinning at the downstream resp. upstream end of the liquid portion. These effects are also achieved by the combined embodiment according to the present application.

During aspiration or dispension of a liquid portion by means of the device according to the present application, respectively, the aspirated or dispensed volume can be increased by discrete increments corresponding to the volumes enclosed by the channel between the phase guides formed by the shoulders, by consecutively applying, in the channel inwards from the liquid portion, an underpressure resp. overpressure with the magnitude of at least the burst pressure upon pinning of the meniscus at the phase guide(s) preceding the phase guide which corresponds to the predetermined volume of the liquid portion to be aspirated or dispensed. The aspirated or dispensed liquid portion may by the device according to the present application thus be accurately dosed during aspiration or dispension, the volume of the liquid portion being defined by the volumes enclosed between the channel opening and the phase guide until which the liquid is advanced by overcoming the meniscus pinning at preceding phase guides. An aspirated liquid portion may subsequently for example be dispensed in its entirety by applying an overpressure inwards from the liquid portion in order to obtain the liquid portion dosed at the defined volume. A device according to the present application enables for example to dispense a part of an aspirated liquid portion covering one or more phase guides, corresponding to a volume between phase guides.

The aspirated liquid portion can in embodiments, if further phase guides downstream of the aspirated liquid portion are present, be advanced further into the channel after release of the fluid connection with the fluid source by again applying the burst pressure one or more times, corresponding to the succeeding shoulders to be passed, a phase front at the upstream end of the liquid portion now also advancing through the channel. In embodiments wherein a sufficient number of phase guides is provided, multiple liquid portions can be aspirated into one channel, separated by one or more non-filled channel portions.

In an attempt to provide an additional means of dosage control, the inventors realized that geometrical variations at the shoulders may yield an additional control parameter during use of the device, in the form of the magnitude of the pressure to be applied for overcoming the meniscus pinning.

During experiments to discover a suitable interrelation between parameters, the inventors found that it depends, among others, on the liquid and the material of the interior surface of the walls of the channel portions which angle of the shoulders is required to cause the flipping of the meniscus from the concave to the convex shape. Where the angle of the meniscus with the preferably hydrophilic internal surface of the advancement portions is known as θ, the angle, denoted by β, at which the wall of the pinning portion should flare out from the advancement portion wall at the shoulder should be larger than 90°-θ in case of a downstream end, and larger than e in case of an upstream end. Therein, the angle θ is the angle that depends on the fluid and interface surface properties.

The inventors have furthermore found that an increase of the flare-out angle β is involved with a higher burst pressure.

The invention is firstly based on the knowledge that whether or not a meniscus is pinned at a shoulder, can be controlled by the magnitude of the pressure applied.

The invention is secondly based on the new insight that the magnitude of the burst pressure at a shoulder can be predetermined by the flare-out angle β,

The invention is thirdly based on the new insight that associating different burst pressures with different shoulders along the array, creates a predictable relation between applied pressure and the progression of the meniscus through the array—and therefore the amount of fluid that is displaced—i.e. (further) aspirated into, (further) dispensed from, and/or (further) advanced through the device.

The association of different shoulders with different burst pressures can be realized by providing different flare-out angles β at different shoulders.

Whereas liquid dosage control in the prior art is merely achieved by employing the relation between the number of times that the burst pressure is consecutively applied and the amount of fluid displaced, the invention provides an additional means of controlling the amount of fluid, as it relates also the magnitude of the applied pressure to the enclosed volume. Whereas in the prior art, the number of times the burst pressure is applied yields a corresponding amount of fluid equal to the volume enclosed by the phase guides at which the meniscus pinning is consecutively overcome, the invention additionally employs the dimension of the pressure magnitude-thus advantageously adding a second control parameter. This may in practical applications provide advantages in terms of simplicity, robustness, predictability and accuracy of dosage control. For example, a more effective manual operation of a pressure application means and/or control algorithms for automated operation thereof may be possible. For example improvements in the resolution of the enclosed volumes may also be possible.

The invention is fourthly based on the new insight that associating increasingly higher burst pressures with shoulders located more downstream in the array along the fluid flow direction yields a positive relation between the amount of pressure and the progression of the fluid through the array.

In a device according to the invention, at least one of the shoulders which in the fluid flow direction succeeds another one of the shoulders, the angle β is larger than the angle β at the other one of the shoulders. In this preferred embodiment, a lower burst pressure is associated with the more upstream shoulder and a higher burst pressure with the more upstream, succeeding, shoulder. This has the effect that application of the lower burst pressure overcomes the meniscus pinning at the upstream shoulder only—the fluid consequently advancing to the downstream shoulder and being pinned there. Application of the higher burst pressure however, overcomes the meniscus pinnings at both of the shoulders, advancing the fluid beyond the second shoulder, e.g. to a next shoulder with an even larger angle β. Thus, with this embodiment, the fluid may be advanced past multiple shoulders by applying pressure a single time. For example this may lead to a more efficient and effective dosage control.

In a possible use, enabled by the inventive device, a liquid portion may be advanced up to the shoulder which is by a liquid portion in the flow direction first encountered, by applying a first pressure lower than the burst pressure associated with the first shoulder. It may be advanced up to the second encountered shoulder by applying a second pressure that is larger than the burst pressure associated with the first shoulder, and lower than the burst pressure associated with the second shoulder. This second pressure may, as an advantage over the prior art, be applied without first having to apply the first pressure.

In all, it follows that the device according to the invention may yield improved control of the dosing of liquid.

The channel of the inventive devices is envisaged to have a circular cross-section, although other shapes are possible within the scope of the invention. In embodiments employing such other shapes of cross-sections, any geometrical terms used in this disclosure that are specific for circular cross-sections are in relation to such embodiments to be taken to mean the relevant equivalent of that term—e.g. diameter is to be taken to mean the effective diameter.

It is noted that throughout this disclosure, the terms ‘upstream’ and ‘downstream’ are used with specific reference to the relevant fluid flow direction. Thus, a downstream direction is into the channel during aspiration and out of the channel during dispension of the liquid. The term ‘inwards’ denotes, independent from the fluid flow direction, a location further into the channel considered from the opening.

Furthermore, it is noted that throughout the disclosure, by ‘applying the burst pressure’ it is intended that in case of liquid flow in the aspiration resp. dispension direction, a pressure with the magnitude of the burst pressure is applied that moves the liquid in the aspiration resp. direction. According to general practice this comes down to the application of an underpressure resp. overpressure downstream of the liquid portion, with a magnitude of the burst pressure.

Throughout the disclosure succeeding channel portions are taken to mean channel portions directly succeeding one another without any further channel portions there between.

Note that the ‘axial boundaries’ are to be taken to mean virtual boundaries which demarcate the axial locations of the coinciding limits of the consecutive channel portions.

The fixed volume, i.e. non-changing volume, of the advancement portions and pinning portions, even as the number of advancement portions and pinning portions provided, may be attuned to the envisaged volume of the liquid portion to be aspirated and dispension, and to the required precision of the dosage: e.g. the channel portions may be smaller as the envisaged volume is smaller and/or the required resolution of the increments in the volume variation is higher.

The circumferential phase guides in the form of the shoulders, practically form pressure barriers. Furthermore, the volume of the liquid portion and the increments of the variation thereof, are associated consistently with the same defined physical portions of the channel which have fixed dimensions and properties. In the control of the flow by varying the pressure inwards of the liquid portion, the provision of the pressure barriers may facilitate accuracy of the liquid dosing at a predetermined volume, as it results in discrete increments in the pressure variance being involved with discrete increments in the volume. Larger discrete increments in the pressure are easier to control than continuous variance thereof, and the associated increments in the volume are less prone to uncertainties in the fluidic resistance and surface tension effects. Furthermore, the discrete form of the control yields a predictable and consistent relation between pressure and volume-whereas the continuous form of pressure control as presently applied may require real-time feedback on the achieved volume and adaptation of the pressure thereon. Moreover, with the present invention the precision and resolution of the dosed volume may be improved: the same variation in pressure is associated with a fixed and accurately defined volume, which may be more accurately be measured and fixed by the design of the channel. In fact, in practice the resolution is defined mainly by the resolution of the production process. For example, a channel portion of the claimed embodiments may with the presently available production processes be sized within the range of magnitude of 10² picoliters, 10¹ picoliters, 10⁰ picoliters, 10¹ femtolitres or 10¹ femtoliters, for example by means of multiphoton lithography, e.g. two-photon polymerization. It is envisaged that even smaller ranges are possible for other embodiments and/or production processes. Small volumes may be accurately dosed, as the required pressure variations involved with the dosing are discrete increments, of which small deviations are substantially not translated into deviations of the volume—in contrast to the continuous pressure control that is conventionally used.

Providing the phase guides in the form of the channel expansions realized by providing the shoulders with the different angles, enables for example that, no other form of phase-guiding being necessary, the entire internal surface of the channel can be made hydrophilic—which may facilitate production.

Various embodiments of the inventive devices are envisaged—of which a part is defined in the subclaims.

Whereas the present application defines meniscus pinning in the aspiration direction and progressively increasing angles for at least two succeeding ones of the shoulders effective for meniscus pinning in this direction, the present application is directed to a device wherein meniscus pinning is additionally achieved in the dispension direction. The present application further specifies that progressively increasing angles are also provided for at least two succeeding ones of the shoulders in the dispension direction—so that the inventive principle is applied in both flow directions. The present application defines meniscus pinning in the dispension direction and progressively increasing angles for at least two succeeding ones of the shoulders effective for meniscus pinning in this direction, and the present application is directed to a device wherein meniscus pinning is additionally achieved in the aspiration direction. The devices according to the present application thus enable dosage by means of volume control during both aspiration and dispension by providing the shoulders in both directions. This enables a user to choose between volume control during aspiration only, dispension only, or both.

A particular design of this embodiment may be such that the angles β of the channel widenings as encountered by the flow in the axial aspiration direction and dispension direction are different. This may for example be done to attune the device to the contact angle of different fluids, so that the device is configured for, or excludes, specific fluids. Or, this may be done to achieve that different burst pressures are involved with advancement in either direction.

The present application defines that in embodiments, the device according to the invention is a micropipette. A micropipette is as such known in the art, even as the use of under- and overpressures in the channel inwards from the liquid portion being aspirated or dispensed by means of the micropipette.

The present application defines that in embodiments, the portion of the liquid the device is suitable for, i.e. a portion that may be dosed by means of the device, has a volume in the range below nanoliters. For example, the device is suitable for dosing liquid portions at a volume in the range of magnitude of 10² picoliters, 10¹ picoliters, 10⁰ picoliters, 10² femtolitres or 10¹ femtoliters. This may be achieved by the dimensioning of the channel portions of the array. For example, an internal volume of a channel portion between the opening and the array may be equal to the envisaged volume, or a combined internal volume of this channel portion and a channel portion of the array that is, when viewed from the opening, subsequent thereto, may together be equal to this envisaged volume of the liquid portion. Additionally or alternatively an internal volume enclosed by one or more of the channel portions of the array, alone or combined, is equal to this volume.

In embodiments according to the present application, three succeeding shoulders are provided with the progressively increasing flare-out angles. Thus, a liquid portion may be advanced up to the first encountered shoulder in the respective direction by applying a first pressure lower than the burst pressure associated with the first shoulder, advanced up to the second encountered shoulder by applying, only once, a second pressure that is larger than the first and smaller than the burst pressure associated with the second shoulder, and up to the third encountered shoulder by applying, only once, an even larger third pressure larger than the burst pressure associated with the second shoulder and smaller than that of the third. This embodiment may advantageously increases the possibilities for application—e.g. in terms of range of volumes of liquid portions to be handled and possible methods.

In embodiments according to the present application, the flare-out angle at all of the shoulders in the aspiration direction and/or the dispension direction, is different, in order to associate each shoulder with a different burst pressure. This yields along the whole channel, unique burst pressures for advancing the meniscus past respective shoulders—and therefore a predictable relation between the pressure to be applied and the liquid volume to be aspirated into, dispensed from, or advanced through the channel. Therein, larger differences between the flare-out angles of the shoulders burst pressures may benefit robustness, accuracy, reliability and similar respective pressures being applicable for a wider range of liquids. After all, larger differences between the flare-out angles lead to larger differences between burst pressures associated with the respective shoulders. For example, this may have the result that a wider range of pressures is effective for progression of the phase front past a certain shoulder without unduly also progressing it past a shoulder downstream thereof which is associated with a larger burst pressure.

Preferably, in these embodiments, the angle of all of the shoulders increases in the aspiration direction and/or the dispension direction—i.e. for each of the shoulders the angle β is larger than the angle β at the one of the shoulders which precedes the shoulder in the respective direction(s). This is defined in the present application. The effect is that along the whole channel, in the respective direction(s), the volume of the liquid portion to be aspirated and/or dispensed increases with the magnitude of the burst pressure to be applied. In accordance with the invention, in aspiration and dispension, irrespective of the desired volume of a liquid portion, a burst pressure has to be advantageously be applied only once, and has a magnitude associated with the shoulder preceding the one up to which the liquid portion should extend to reach the desired volume. The same applies for further advancing an already aspirated liquid portion through the channel: the user has to apply only once the burst pressure associated with the shoulder preceding the one up to which he desires the liquid portion to extend.

Embodiments according to the present application, may enable uses wherein it is desired to aspirate and/or dispense liquid portions in parts, or wherein it is desired to hold multiple liquid portions in one device, e.g. separated from each other. The associated burst pressure has to then be applied the number of times according to the number of parts and/or separate portions. In an example use for aspiration, a first part of a liquid portion may be aspirated up to the most downstream shoulder of the first set, by applying the burst pressure associated with the preceding shoulder, filling up the first set with the liquid. A second part of the liquid portion may subsequently be aspirated up to a shoulder of the second set by applying the burst pressure associated with the most downstream shoulder of the first set, advancing the meniscus further through the device and filling up now also (a part of) the second set with the liquid, therein being careful to remove or reduce the pressure before it has a chance to flow past the shoulder of the second set having a smaller angle than the most downstream one of the first set and being the one up to which the liquid should progress. In another example use for aspiration, a first separate liquid portion is aspirated into the device and advanced further into the device up to a shoulder of the first set, leaving also a channel portion upstream of the liquid portion empty. A second separate liquid portion, e.g. of the same volume, is subsequently aspirated into the device, advancing the first liquid portion further into the device up to a shoulder of the second set, and the second liquid portion up to a shoulder of the first set, again being careful to timely remove the pressure for preventing the liquid to progress too far. Other possible uses may also be envisaged. In examples, the different sets may, depending on the suited purpose, be dimensioned to hold the same or different volumes.

The inventors have found that the increase in the burst pressure associated with increasing flare-out angles decreases with increasing flare-out angles. It is therefore envisaged that it may be desirable, e.g. to facilitate uses wherein pressures are to be increased in equal steps for advancement up to succeeding shoulders, to embody the device such that the flare-out angles of succeeding shoulders increases increasingly to such an extent that the burst pressure increases proportionally with the number of shoulders successively encountered in the flow direction(s). Furthermore, embodiments are envisaged wherein the angles of all, or almost all, of the shoulders remains below a certain limit, for example approximately 75 degrees, 70 degrees, 65 degrees, 60 degrees, 55 degrees, 50 degrees or 45 degrees, to remain in a fairly proportional part of the relation between the angle and the burst pressure. In an embodiment according to the present application, the angles at the succeeding shoulders with increasingly larger angles for meniscus pinning are below 70 degrees for at least all but the most downstream one of these succeeding shoulders. This may be the case in one or both of the flow directions.

The present application defines that in embodiments, multiple advancement portions of the array have equal internal volumes. For example in embodiments according to the present application, portions, e.g. corresponding portions, along the sets may be identically shaped and oriented. Additionally or alternatively the pinning portions of the array may have equal internal volumes, e.g. being identically shaped and oriented. Besides advantages in production, these embodiments may have the effect that the volume of liquid portions in the channel may be dosed, or increased—in case of aspiration—or decreased—in case of dispension—by consistent increments by application of an associated burst pressure. For example in an embodiment realizing proportionally increasing burst pressures with the succession of the shoulders, the aspirated, dispensed or advanced volume of the liquid portion may with equally enclosed volumes there between, additionally be made proportional to the applied pressure.

A further result of portions having equal volumes, may be that the same dosed liquid portion may be enclosed by corresponding channel portions at multiple axial positions along the array. For example a liquid portion dosed at the volume of one advancement portion can be enclosed by another one of the advancement portions having equal volume, so that it can be contained by the device within a selected one thereof, achievable by advancement through the channel. In an example wherein combinations of pinning and advancement portions have equal volumes, a liquid portion dosed at the volume of two advancement portions and one intermediate pinning portion can be contained by the device within a selected combination of two consecutive advancement portions and one intermediate portion, and so on.

In embodiments, as defined in the present application, the internal volumes of the one or more, e.g. all, of the advancement portions of the array are furthermore equal to the internal volumes one or more, e.g. all, of the pinning portions thereof. This has the additional result that liquid portions with a volume dosed at the internal volume of one, or multiple consecutive channel portions may be contained by any one, or multiple consecutive ones, of the channel portions of the array.

The present application defines that in embodiments, the channel portions of the array are each axisymmetrical with respect to an axially extending center axis, in examples the array of the channel portions being axisymmetrical with respect to the center axis along its entire axial extension. This may ease manufacturing of the device.

The present application defines that in embodiments, the opening is formed at an axial end of a first one of the channel portions of the array. In an example the first one of the channel portions is an advancement portion, which has the effect that aspiration results in the meniscus being pinned at the other axial end of the first one of the channel portions of the array. Thus, the liquid portion can be dosed by capillary flow only to the internal volume of this advancement portion only. In another example the first one of the channel portions is a pinning portion, so that the liquid portion can be dosed by capillary flow only to the internal volume of this pinning portion and the subsequent advancement portion together, since the meniscus is in the aspiration pinned at the axial boundary with the pinning portion subsequent thereto.

The present application defines that in embodiments the angle at which the wall of each pinning portion flares out from the wall of the preceding advancement portion at the respective axial boundaries is in a range of 0-75°, e.g. in a range of 5-70°. In other embodiments, angles within other ranges may also be effective. However, the claimed range is expected to provide the largest advantageous effects—since in the relation between the flare-out angle and the burst pressure, the burst pressure is found to be most sensitive to changes in the flare-out angle in this range. As pointed out before, this sensitivity decreases with increasing flare-out angle.

The present application defines that the array may be formed by 4-30 channel portions, for example 10-20 channel portions. In examples the array has 10 channel portions, consisting of 5 advancement portions and 5 pinning portions. In examples the array has 15 channel portions, consisting of 8 advancement portions and 7 pinning portions, or 7 advancement portions and 8 pinning portions. In examples the array has 20 channel portions, consisting of 10 advancement portions and 10 pinning portions. Other examples of the amount of channel portions are envisaged within the scope of the invention.

In embodiments as defined in the present application, the device is formed at least partly as a probe of a microfluidic atomic force microscope (AFM). Microfluidic AFMs are as such known in the art. The device thereto exhibits all the properties as known in the art to render it suitable for this application.

The invention furthermore relates to a device according to the present application, wherein the angles at the shoulders for meniscus pinning are all between approximately 65 and 85 degrees, e.g. approximately 70-75 degrees. This inventive device is based on the insight that the variation in burst pressure associated with shoulders at which the angle is within these ranges, is limited when compared to the angle range of 0-70 degrees. This device forms at least an alternative to the device according to the preambles as known from WO0185342 in FIG. 2, wherein these angles are 90 degrees. The inventive device may e.g. yield advantages in production and may facilitate a larger resolution e.g. by enabling smaller volumes of advancement portions. As the skilled person will recognize, such device may also be embodied as described herein in relation to the inventive device as claimed, in as far any specifications are not contradictory. For example, the device may in particular be embodied according to the present application to achieve the advantages discussed in relation thereto. An embodiment in accordance with the present application that would be mostly contradictory is not envisaged. Other embodiments are possible, through the advantageous effects thereof may obviously be reduced.

The invention furthermore relates to a device according to the present application, wherein the angles at shoulders for meniscus pinning in the aspiration direction are different from the angles at shoulders for meniscus pinning in the dispension direction. This may yield several advantages in practical applications, e.g. emanating from the fact that different magnitudes of burst pressures are associated with a different flow direction.

The invention furthermore relates to a device according to the present application, wherein the device is configured to form by at least a part thereof a probe, or a part thereof, of a microfluidic atomic force microscope, a tip of the probe at a free-swinging end thereof providing the opening and the channel extending along a length of the probe over which a deflection takes place during use of the probe. Embodying a device according to the preamble in this way, advantageously enables to use the device in atomic force microscopy. This inventive device is embodied in the way as known from the prior art in order to give it the properties necessary for application as a probe and be compatible with an AFM microscope. In particular, the device is manufactured by a manufacturing method according to the present application.

The invention furthermore relates to a device according to the present application, wherein multiple succeeding ones of the channel portions have equal internal volumes.

The invention furthermore relates to a device according to the present application, wherein the opening is formed at an axial end of a first one of the channel portions of the array, for example wherein the first one of the channel portions is an advancement portion.

The invention furthermore relates to a microfluidic atomic force microscope comprising the device according to the invention—as defined in the present application.

The invention furthermore relates to methods of dosing a liquid, which are defined in the present application.

The invention furthermore relates to a method of manufacturing a device according to the invention, defined in the present application.

The invention will hereinafter be described with reference to the appended drawings.

### BRIEF DESCRIPTION OF THE DRAWINGS

FIG. 1 illustrates, schematically, a prior art micropipette formed as a probe of a microfluidic atomic force microscope,

FIG. 2 illustrates, schematically, a prior art use of the micropipette of FIG. 1 including aspiring, containing and dispensing a liquid portion,

FIGS. 3a to 3b illustrate schematically, principles of capillary flow,

FIG. 4 illustrates schematically the principle of meniscus pinning as applied in the invention during advancement of a liquid in the aspiration direction,

FIG. 5 illustrates schematically the principle of meniscus pinning as applied in the invention during advancement of a liquid in the dispension direction,

FIG. 6a illustrates schematically, in a cross-sectional side view, an embodiment of a device according to inventive principles of this disclosure, including a magnification of a detail, during a first use of the device,

FIG. 6b illustrates schematically, in a cross-sectional side view, a second use of the same device,

FIG. 7 illustrates schematically, in a cross-sectional side view, a use of a further embodiment of a device according to inventive principles of this disclosure,

FIGS. 8a-c illustrate schematically, in a cross-sectional side view, embodiments of a device according to inventive principles of this disclosure,

FIGS. 9a-b illustrate schematically, in a cross-sectional side view, a further embodiment of a device according to the invention as claimed,

FIG. 9c illustrates schematically the embodiment of FIGS. 9a-b in a perspective side-top-rear view,

FIG. 10 illustrate results of experiments conducted with the embodiment of FIGS. 9a-c, and

FIG. 11 illustrates schematically, in a cross-sectional side view, a use of a device according to the present application.

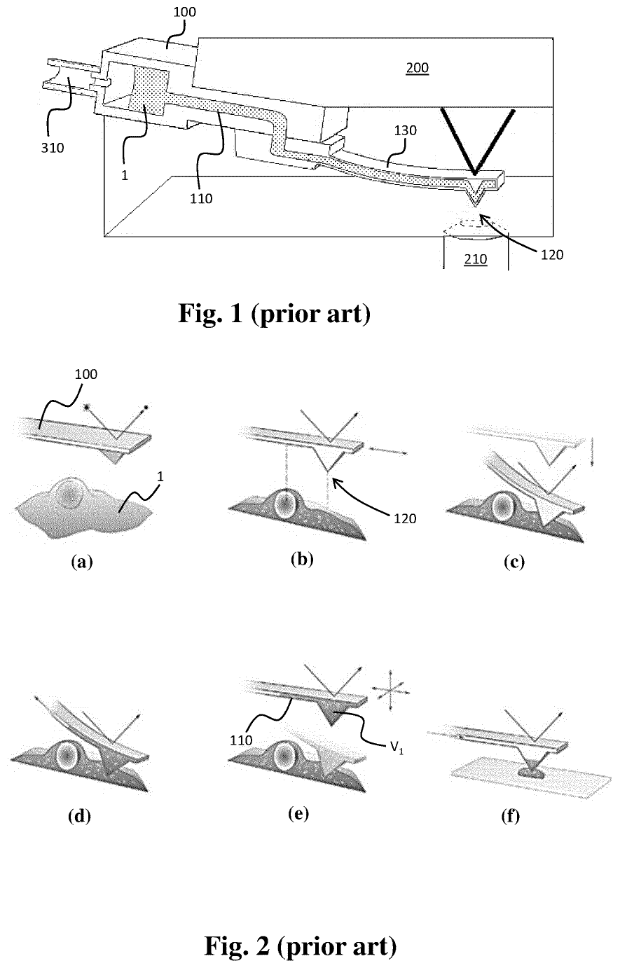

FIG. 1 illustrates an axial-diametrical cross-section through a known micropipette 100 formed, and being applied, partly as a probe 130 of a microfluidic AFM microscope 200. The probe has a channel 110 which extends from an opening 120 provided by a tip of the probe at a free-swinging end thereof along a length of the probe 100 over which a deflection takes place during use of the probe 100, and further into a non-deflecting part of the device 100. The probe 130 is restrained at the other end, being fixed relative to the rest of the microscope 200, so that the probe is enabled to deflect as a leaf spring enabling its functionality in the measurement of contours in the way that is known in the art. In the illustrated situation, the probe 130 has aspirated and contains a portion of a liquid 1 to be analyzed by optical microscope 210 after dispension of the liquid 1. The liquid is shown by the dotted shading. A beam deflection measurement is depicted by the thick line, illustrating the laser beam being reflected off the top surface of the probe 130. The external channel 310 is in fluid communication with the device 100, via which under- and overpressures can be applied in the channel inwards from the liquid portion for controlling aspiration, containment and dispension of the fluid portion.

FIG. 1 is reproduced and edited from Guillaume-Gentil, O., Potthoff, E., Ossola, D., Franz, C. M., Zambelli, T., & Vorholt, J. A. (2014). Force-controlled manipulation of single cells: from AFM to FluidFM. Trends in biotechnology, 32(7), 381-388.

FIG. 2 illustrates in (a) and (b), bringing the opening 120 at the tip of the probe 130 proximate a source of the liquid 1, in (c) bringing the channel 110 into fluid communication with the liquid 1 via the opening 120 by downwardly deflecting the probe 130, in (d) aspiration of a portion of the liquid 1, wherein an underpressure is applied in the channel 110 inwards from the liquid portion being aspirated, in (e) releasing the fluid communication, and containment of the aspirated liquid portion now having a volume P₁, and finally in (f) dispension of the liquid portion P₁ onto the glass surface for analysis by the optical microscope 210.

FIG. 2 is reproduced and edited from Guillaume-Gentil, O., Grindberg, R. V., Kooger, R., Dorwling-Carter, L., Martinez, V., Ossola, D., . . . & Vorholt, J. A. (2016). Tunable single-cell extraction for molecular analyses. Cell, 166(2), 506-516. The accuracy of the dosage of the liquid portion P₁ by means of pressure control inwards from the liquid portion P₁ via the channel 310 is unsatisfactory.

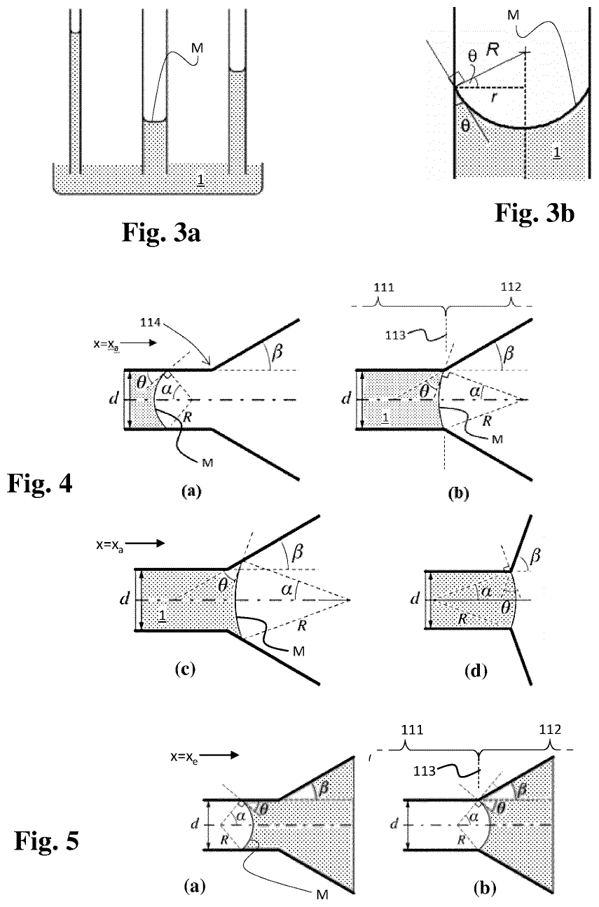

FIGS. 3a and 3b illustrate capillary action of a liquid into three different channels dimensioned at the microscale—a liquid 1 again being represented by dotted shading. Gravity being negligible at the microscale, makes that the liquid 1 enters and advances through the channels until stopped upon reaching an equilibrium between surface tension and external forces. The capillary effect increases a capillary pressure, and therefore advances the liquid 1 further into the channel, as the channel diameter decreases. The capillary pressure, and therefore the extent of advancement, scales positively with the surface tension and the contact angle θ of the meniscus M of the phase front with the internal surface of the channel wall—the meniscus M having a radius R, the contact angle θ being enclosed between the radius R and the radius r of the channel—and therefore the flow, as illustrated. These effects and relations are well known in the art. The contact angle θ is smaller than 90° for the hydrophilic surface of the channel—which causes the liquid meniscus M to advance by capillary flow until stopped.

FIG. 3a is reproduced and edited from http://rieson.blogspot.com/2012/12/capillary-action.html.

FIG. 4 now shows how the capillary flow is stopped according to the principles underlying the invention. Parts (a) and (b) illustrate capillary flow of the liquid 1 through an upstream channel portion 111 wherein the meniscus M at an upstream end of a portion of the liquid 1 advances to an axial boundary 113 with a downstream channel portion 112. At the axial boundary 113, flipping of the meniscus M from its concave shape to a convex shape is effectuated by letting the contact angle θ with an internal surface of a downstream channel portion 112 exceed 90° over the entire channel circumference, so that the meniscus M does not advance through this downstream channel portion 112, but is instead pinned at the axial boundary 113, the advancement thereby being stopped. This is established by providing a phase guide along the entire circumference. FIG. 5 shows how the capillary flow is stopped at the same axial boundary due to a downstream end of the portion of the liquid encountering the axial boundary 113. Here the meniscus is not flipped, however is also pinned at the axial boundary. In both of the cases of FIGS. 4 and 5, the meniscus advances through the channel portion 112 only when a burst pressure is overcome—which is in practice generally accomplished by applying respectively an underpressure downstream, and overpressure upstream, of the pinned meniscus.

In the shown case, the phase guiding is realized by letting the meniscus M encounter a sudden expansion of the channel by an angle β with the wall 111w of the upstream channel portion 111. A shoulder 114 is provided at the axial boundary between the channel portions 111, 112 by having a wall 112w of the downstream flare out radially outwardly from the wall 111w of the upstream channel portion. To achieve the flipping of the meniscus M, the angle β must be larger than 90°-θ, which is the case in part (d) of FIG. 5. In figure (d), the shoulder 114 thus effectively acts as a phase guide. If the angle is however equal to or not larger than 90°-θ, as shown in part (c) of FIG. 4, the meniscus M will not be stopped, but continue to advance beyond the shoulder through the downstream channel portion 112. Thus the angle β is here insufficient to let the shoulder 114 act as a phase guide.

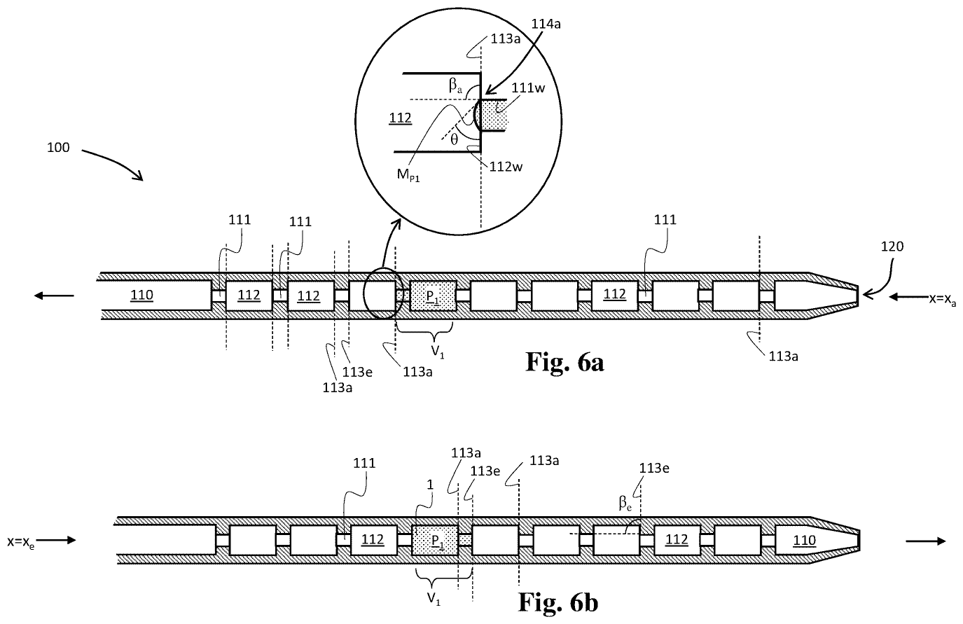

The principle shown in FIGS. 4 and 5 is for the purpose of illustrating it, applied in the exemplary embodiments of the device according to the present application which are shown in FIGS. 6a,b, 7, 8a,b,c, and 11 and all employ phase guides in the form of shoulders 114 at multiple, axially spaced axial boundaries 113 between adjacent channel portions 111, 112. These exemplary embodiments show different inventive principles according to this disclosure.

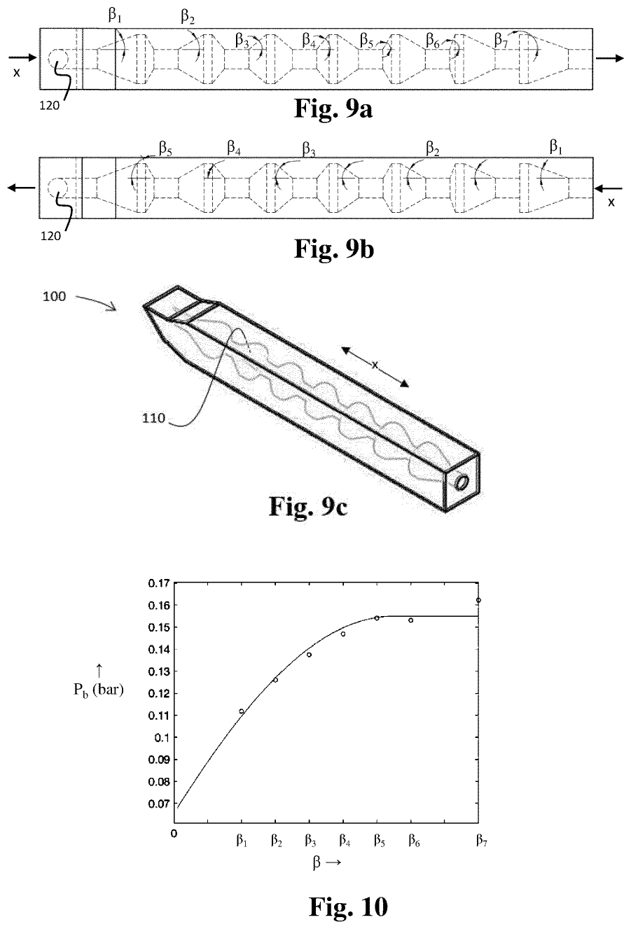

FIGS. 9a,b illustrate exemplary embodiments of the device according to the invention as claimed.

In each of the exemplary embodiments shown, the device 100 comprises a channel 110 which ends in an opening 120 of the device 100. The channel 110 is configured for capillary flow of the liquid portion P₁ therethrough, amongst others by the geometry thereof. The channel 110 is formed along at least a part of its axial extension by a continuous array of, fixed-volume, advancement portions 111 and pinning portions 112, each of the channel portions 111,112 having a respective wall 111w, 112w with a hydrophilic internal surface enclosing an internal volume of the channel portion.

In each of the exemplary embodiments shown, and as not yet known from the prior art as mentioned, the advancement portions 111 of the array have equal internal volumes, and the pinning portions 112 of the array have equal internal volumes. This property enables that a liquid portion dosed at the internal volume of one or more of the channel portions can be contained at multiple positions in the channel whilst being enclosed by corresponding channel portions 111,112. Furthermore, it enables that the discrete increments by which the volume of a liquid portion being dosed by aspiration and/or dispension, can be increased, are equal and consistent throughout the channel 110, since volumes enclosed between subsequent phase guides are equal. The advancement portions 111 are in each of the embodiments shown in FIGS. 6a,b, 7, 8a,b,c furthermore identically shaped and oriented. In these embodiments the pinning portions 112 are identically shaped and oriented as well.

In each of the exemplary embodiments shown, the channel portions 111,112 of the array are each axisymmetrical with respect to an axially extending center axis, e.g. the array of the channel portions being axisymmetrical with respect to the center axis along its entire axial extension.

It is referred firstly to FIGS. 6a and 6b both depicting the same, first embodiment of a device 100 according to the present application, during two different uses according to the inventive principles of this disclosure. The channel 110 of this embodiment of the device 100 has an array of ten, identical, advancement portions 111, thus having equal internal volumes, and nine, identical, pinning portions 112, thus also having equal internal volumes. The advancement portions 111 and pinning portions 112 alternate one another. A portion of the channel 110 between the array and the opening 120 has a volume which is equal to the internal volume of one pinning portion 112.

The device 100 is shown in FIG. 6a after a portion P₁ of the liquid 1 has been aspirated through the opening 120 and into the channel 110 in axial aspiration direction xₐ, and has been advanced through multiple of the channel portions 111, 112, to be enclosed by an advancement portion 111 and one, subsequent, pinning portion 111, 112 halfway the array. Thus, the volume V₁ of the liquid portion is defined by the added internal volumes of one pinning portion and one advancement portion. As is shown in the magnification in the circle, the axial boundary 113a between each advancement portion 111 of the array and a respective pinning portion 112 thereof which succeeds the advancement portion 112 in the axial aspiration direction xₐ, a shoulder 114a is formed along an entire circumference of the channel by a wall 112w of the pinning portion flaring radially outwardly from a wall 111w of the advancement portion at the axial boundary, at an angle βₐ with the advancement portion wall 112w. Upon advancement of the liquid portion P₁ through the channel 110 in the axial aspiration direction xₐ by capillary action, the liquid portion P₁ thus encounters an expansion of the channel 110 at the shoulder 114a at each axial boundary 113a. As is shown in the magnification, a meniscus M_{V1} of the liquid portion P₁ at a downstream end of the liquid portion P₁ is thereby pinned at the respective axial boundary 113a. The addition of the letter ‘a’ to the reference numbers of the axial boundaries 113, shoulders 114 and angles β denotes that these are the respective axial boundaries 113 and shoulders 114 of this embodiment that cause the pinning of the meniscus M_{P1} in the capillary flow in the aspiration direction xₐ. The aspiration and advancement of the liquid portion P₁ in the aspiration direction xₐ is in practice generally effectuated by applying an underpressure in the channel 110 inwards from the array.

The shown position of the liquid portion P₁ has been achieved by the following use of the device. Firstly, the liquid 1 has been aspirated by capillary flow through the opening 120 with the channel 110 in fluid communication with a source of the liquid, until stopped by a first meniscus pinning at the indicated boundary 113a. After releasing the fluid communication with the liquid 1 to finish aspiration, an underpressure with a magnitude of the burst pressure has been applied in the channel 110 inwards from the array, to overcome the first meniscus pinning and initiate advancement of the now completely aspirated liquid portion P₁ through the subsequent advancement and pinning portion, until again the meniscus is pinned at the axial boundary with the pinning portion downstream thereof, and the liquid portion P₁ is now enclosed by the advancement and pinning portion. The underpressure with the magnitude of the burst pressure is applied again to overcome the pinning—which is repeated five more times at the subsequently encountered axial boundaries, to advance the liquid portion further to the depicted position.

In the use of this embodiment shown in FIG. 6a, it is noted that the liquid portion has a volume that is defined by two subsequent phase guides, and the smallest to be defined as a volume step. As may be envisaged from FIG. 6a, in other uses, liquid portions with volumes that are a multiplicity of V₁ may be aspirated and advanced, up to a volume that is ten times as large—as there are ten axial boundaries 113a provided for providing meniscus pinning in the aspiration direction. Therein, the burst pressure must during aspiration be applied as an underpressure a number of times at subsequently encountered axial boundaries that is equal to this multiplicity, whilst maintaining the fluid communication with the liquid source.

As is visible in the magnification in the circle, the shoulders 114a forming the phase guides for capillary flow in the aspiration direction xₐ are formed by flaring out of the pinning portion wall 112a all at the same angle βₐ of 90° as is known from the prior art.

FIG. 6b shows the same embodiment of the device 100 as in FIG. 6a, now being used whilst advancing the liquid portion P₁ in the dispension direction xₑ through the channel 110 towards the opening. The device 100 is furthermore configured for volume control in this direction, since the array of channel portions 111,112 is furthermore formed such that at an axial boundary 113e between each advancement portion 111 of the array and a respective pinning portion 112 thereof which succeeds the advancement portion in the axial dispension direction xₑ, a shoulder 114e is formed along an entire circumference of the channel by a wall 112w of the pinning portion flaring radially outwardly from a wall 111w of the advancement portion at the axial boundary 113e, at an angle βₑ with the advancement portion wall 112w, such that upon advancement of the liquid portion through the channel in the axial dispension direction by capillary action, the liquid portion encounters an expansion of the channel at the shoulder at each axial boundary, a meniscus M_{P1} of the liquid portion at a downstream end of the liquid portion thereby being pinned at the respective axial boundary. Alike the shoulders 114a for the aspiration direction, also the shoulders 114e for the dispension direction are formed by flaring out all at the same angle βₑ of 90° as known from the prior art.

To achieve the advancement in the axial dispension direction xₑ and the subsequent dispension, an overpressure is applied in the channel 110 inwards from the array. The shown position has been achieved from the position of FIG. 6a by once applying an overpressure having a magnitude equal to the burst pressure, so that meniscus pinning occurs at the indicated first encountered axial boundary 113e. Applying the same overpressure five more times upon the meniscus pinnings at the subsequently encountered axial boundaries 113e in the advancement in the dispension direction xₑ, yields a position of the volume in which the meniscus M_{P1} is pinned at the opening 120. From this position, dispension can be effectuated by once again applying the same or a larger overpressure.

From the above explanation in relation to the exemplary embodiment of FIGS. 6a,b,c, the inventive principle of having equal volumes for the pinning and advancement portions yields particular advantages and opens up further possibilities for the use of the device. This applies to the invention as claimed as well—in particular for the embodiment according to the present application.

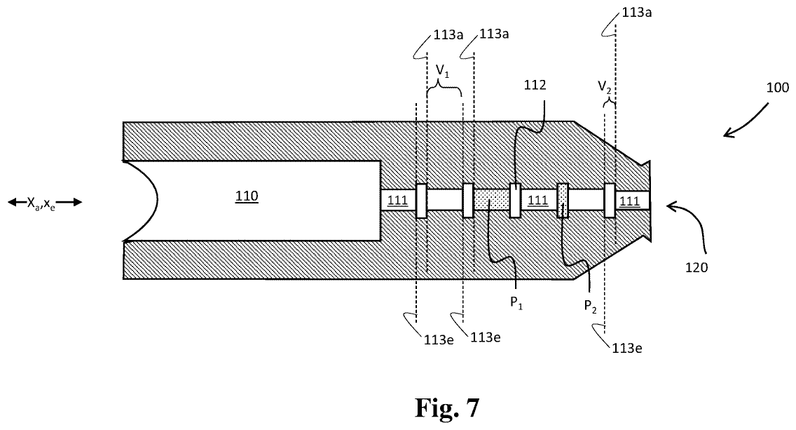

FIG. 7 illustrates a further exemplary embodiment of the device according to the present application. The channel 110 of this device 100 is formed by a continuous array of six identical advancement portions 111 and five identical pinning portions 112. The device 100 is shown containing two liquid portions P₁ and P₂ of which the volumes V₁ and V₂ are equal, i.e. V₁=V₂. The first liquid portion P₁ is contained in an advancement portion 111, and the second in a pinning portion 112. This is made possible by the feature of this embodiment and according to one of the inventive principles of this disclosure, that the internal volumes of the advancement portions 111 are equal to the internal volumes of the pinning portions 112 thereof.

The opening 120 is in this embodiment formed at an axial end of a first one of the portions 111,112 of the array, in particular, an advancement portion of the array. This enables that aspiration already involves meniscus pinning, and thus stopping of the capillary flow of the liquid 1 into the channel 110, as soon as this advancement portion 111 is filled with the liquid 1. After all the first encountered phase guide in the aspiration is the boundary 113a with the first encountered pinning portion 112 already. This has the result that the smallest liquid portion that can be controllably dosed by meniscus pinning, has the internal volume of an advancement portion 111. In the situation as shown, the two contained liquid portions P₁, P₂ both have this smallest volume V₁=V₂. Thus, the internal volume of the advancement portions, in this embodiment equal to that of the other advancement portions and to that of each of the pinning portions, defines the resolution of the array.

From this illustrative exemplary embodiment it can be verified that the configuration according to one of the inventive principles of this disclosure, and captured for the invention as claimed herein, with an advancement portion of the array having the opening, thus yields particular benefits to the resolution of the volume control in the dosage of liquid portions.

The positions of the liquid portions P₁ and P₂ can be achieved by the following use of the device 100, which accords to the present application. Firstly, the portion P₁ of the liquid 1 is aspirated through the opening 120 of the device 100 into the channel 110 thereof. This involves capillary flow of the liquid portion P₁ into the channel 110 from a source of the liquid 1, the channel 110 being in liquid communication with this source via the opening 120, until the meniscus M_{P1} of the liquid portion P₁ at the downstream end of the liquid portion P₁ is pinned at the axial boundary 113a between the advancement portion 111 of the array having the opening 120 and the pinning portion 112 thereof which succeeds this advancement portion 110 in the axial aspiration direction xₐ. The liquid communication with the source is released so as to finish the aspiration, the device now containing the liquid portion P₁ in the channel 110 thereof inside the advancement portion 111 of the array having the opening 120. The aspirated and contained liquid portion has a volume V₁ defined by the internal volume of the advancement portion 111 now filled by the aspirated and contained liquid portion P₁.

After the aspiration, an underpressure with a magnitude of at least the burst pressure P_{b} is applied in the channel 110 inwards from the liquid portion P₁, in particular via the part of the channel that is inwards from the array, so as to overcome the pinning of the meniscus M_{P1} thereby initiating continued capillary flow of the aspirated liquid portion P₁ through the array of channel portions 111,112 in the axial aspiration direction xₐ until the meniscus is pinned at a succeeding axial boundary 113a. The result is that P₁ is contained in the second advancement portion 111 seen from the opening 120, and the advancement portion 111 and pinning portion 112 of the array upstream of the aspirated liquid portion P₁ are not filled with the liquid 1. Thereafter, the second portion P₂ of the liquid 1 is aspirated through the opening 120 of the device 100 into the channel 110 thereof, the aspiration of the second portion involving capillary flow of the second liquid portion into the channel until the meniscus of the second liquid portion P₂ at the downstream end of the second liquid portion P₂ is pinned at the first encountered axial boundary 113a between the advancement portion 111 of the array having the opening and the pinning portion 112 thereof which succeeds this advancement portion 111 in the axial aspiration direction xₐ. The aspiration of the second liquid portion P₂ comprises applying an underpressure with a magnitude of at least the burst pressure P_{b} in the channel 110 inwards from the already aspirated first liquid portion P₁, in particular at the part of the channel 110 inwards from the array, so as to overcome the pinning of the meniscus M_{P1} at the downstream end of the first liquid portion P₁ thereby initiating both the continued capillary flow of the first liquid portion P₁ through the array in the axial aspiration direction xₐ until the meniscus M_{P2} is pinned at the first encountered axial boundary 113a, and the aspiration of the second liquid portion P₂. The result is that the second liquid portion P₂ is contained by the device 100 in the channel 110 thereof in the first advancement portion 111 of the array, having the opening, and that the first liquid portion P₁ is now contained in the second pinning portion 111 of the array, seen from the opening. Two non-filled channel portions are now in between the two aspirated and contained liquid portions P₁, P₂. The liquid communication with the source of the liquid 1 is released again to finish the aspiration, and the underpressure of at least the burst pressure is applied three more times, to overcome subsequent meniscus pinnings of the second, the first, and again the second liquid portion at the channel widenings respectively encountered thereby, to advance both portions into the shown position.

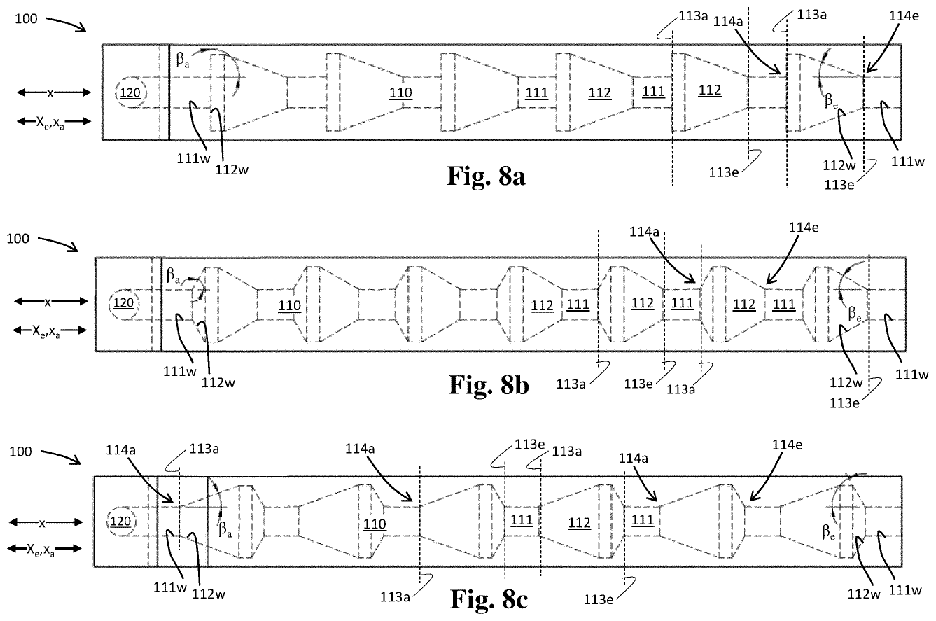

FIGS. 8a, 8b and 8c show three respective embodiments of the device 100 according to another inventive principle of this disclosure. Each of these embodiments has a different angle βₐ of the pinning portion walls 112w relative to the advancement portion walls 111w at the shoulders 114a forming the phase guides in the aspiration direction xₐ. Furthermore, each of these embodiments has a different angle βₑ of the pinning portion walls 112w relative to the advancement portion walls 111w at the shoulders 114e forming the phase guides in the dispension direction xₑ. In each respective embodiment, furthermore, the angle βₐ differs from the angle βₑ.

As mentioned earlier, the contact angle θ, and thus the required angle βₐ and βₑ to achieve meniscus pinning at the shoulders 114a, 114b, as explained in relation to FIG. 5, depends amongst others on the properties of the liquid and of the internal surface of the channel 110 at the interface with the liquid 1. Thus, designs of embodiments of the device 100 according to the invention may include attuning the angles βₐ and βₑ to the envisaged application, e.g. the liquid to be used and/or e.g. the volume control by meniscus pinning being applied through the aspiration, dispension, or both. A variation in the angles βₐ and/or βₑ may be used as well in designing the device 100 in order to optimize a volume of liquid portions to be dosed, and/or a resolution of the volume control.

Furthermore, the angles βₐ and/or βₑ may in designing embodiments of the device 100 be chosen in order to set the required burst pressure P_{b} for overcoming the meniscus pinning to a desired magnitude. As explained before the inventors have found experimentally a relation between the angle β and the burst pressure P_{b}.

FIGS. 9a, b and c show an embodiment of the device 100 according to the invention which is furthermore according to the present application. In both the aspiration direction xₐ and the dispension direction xₑ, the angles β increase for the shoulders at the subsequent axial boundaries-see FIGS. 9a and 9b respectively. Advantages of this embodiments have been discussed herein in relation to the present application.

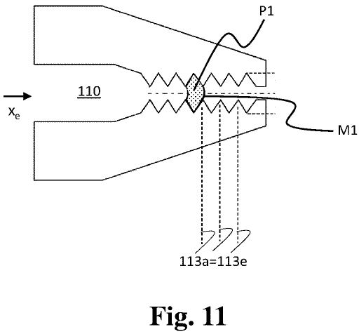

This same device also may be used to determine the relation between the angle β and the burst pressure P_{b}. In the experiments as executed by the inventors, liquid portions of a particular liquid were advanced through the channel and required burst pressures upon meniscus pinning at the subsequently encountered shoulders were determined. The results, shown in FIG. 10, appear to indicate a decreasing increase of the burst pressure P_{b} with the angle β. It appears that in the upper range of angles, around 60-90°, the required burst pressure P_{b} is approximately the same for this liquid. Thus, according to another one of the inventive principles of the disclosure, within this range, the angles in a device according to the present application could for example be chosen to optimize other properties of the device, without significantly affecting the required burst pressure P_{b}.

FIG. 11 shows an embodiment according to a further inventive principle of the disclosure, according to which the array consists of alternating widening and narrowing portions only. Therein, each of the axial boundaries 113a, 113e at which the phase guides are formed are each effective for both axial directions, so as to coincide with one another: The pinning portions in the axial aspiration direction form the advancement portions in the dispension direction and vice versa. This embodiment is advantageously particularly simple, robust, high-resolution and compact. The principle of this embodiment may also be applied to the inventive device as claimed, by providing the narrowings and widenings with different angles.

It is emphasized that the features discussed in relation to specific embodiments, e.g. discussed in relation to the figures, may be applied alone or in combination to other embodiments of devices within the scope of the disclosure for achieving similar advantages and effects, in as far as these are not contradictory.

1-30: (canceled)

31. A device for dosing a liquid,
wherein the device comprises a channel which ends in an opening of the device, for aspiration of a portion of the liquid through the opening and into the channel in an axial aspiration direction, wherein the channel is configured for capillary flow of the liquid portion therethrough,
wherein the channel is formed along at least a part of its axial extension by a continuous array of channel portions, wherein at least two fixed-volume, advancement portions are in the axial aspiration direction each directly succeeded by a respective, fixed volume, pinning portion, each of the channel portions having a respective wall with an internal surface enclosing an internal volume of the channel portion,
wherein the array of channel portions is formed such that at an axial boundary between each advancement portion of the array and the pinning portion succeeding the advancement portion in the axial aspiration direction, a shoulder is formed along substantially an entire circumference of the channel by a wall of the pinning portion flaring radially outwardly from a wall of the advancement portion at the axial boundary, at an angle with the advancement portion wall, seen in a diametrical cross-section of the channel,
such that seen in the axial aspiration direction an expansion of the channel is formed at the shoulder at each axial boundary, for pinning of a meniscus of the liquid portion at the respective axial boundary,
wherein of the shoulders for meniscus pinning in the axial aspiration direction, at least one of the shoulders which in the aspiration direction succeeds another one of the shoulders, the angle is larger than the angle at the other one of the shoulders.

32. The device according to claim 31,
the channel and opening furthermore being suitable for dispension of the liquid portion through the opening and out of the channel in an axial dispension direction,
wherein the array of channel portions is furthermore formed such that at an axial boundary between each advancement portion of the array and a respective pinning portion succeeding the advancement portion in the axial dispension direction, a shoulder is formed along substantially an entire circumference of the channel by a wall of the pinning portion flaring radially outwardly from a wall of the advancement portion at the axial boundary, at an angle with the advancement portion wall, seen in a diametrical cross-section of the channel,
such that seen in the axial dispension direction an expansion of the channel is formed at the shoulder at each axial boundary, for pinning of a meniscus of the liquid portion at the respective axial boundary.

33. The device according to claim 32, wherein of the shoulders for meniscus pinning in the axial dispension direction, at least one of the shoulders which in the dispension direction succeeds another one of the shoulders, the angle is larger than the angle at the other one of the shoulders.

34. A device for dosing a liquid,
wherein the device comprises a channel which ends in an opening of the device, for dispension of a portion of the liquid through the opening and into the channel in an axial dispension direction,
wherein the channel is configured for capillary flow of the liquid portion therethrough,
wherein the channel is formed along at least a part of its axial extension by a continuous array of channel portions, wherein at least two fixed-volume, advancement portions are in the axial dispension direction each directly succeeded by a respective, fixed volume, pinning portion, each of the channel portions having a respective wall with an internal surface enclosing an internal volume of the channel portion,
wherein the array of channel portions is formed such that at an axial boundary between each advancement portion of the array and the pinning portion succeeding the advancement portion in the axial dispension direction, a shoulder is formed along substantially an entire circumference of the channel by a wall of the pinning portion flaring radially outwardly from a wall of the advancement portion at the axial boundary, at an angle with the advancement portion wall, seen in a diametrical cross-section of the channel,
such seen in the axial dispension direction an expansion of the channel is formed at the shoulder at each axial boundary, for pinning of a meniscus of the liquid portion at the respective axial boundary,
wherein of the shoulders for meniscus pinning in the axial dispension direction at least one of the shoulders which in the dispension direction succeeds another one of the shoulders, the angle is larger than the angle at the other one of the shoulders.

35. The device according to claim 34, the channel and opening furthermore being suitable for aspiration of the liquid portion through the opening and out of the channel in an axial aspiration direction,
wherein the array of channel portions is formed such that at an axial boundary between each advancement portion of the array and the pinning portion succeeding the advancement portion in the axial aspiration direction, a shoulder is formed along substantially an entire circumference of the channel by a wall of the pinning portion flaring radially outwardly from a wall of the advancement portion at the axial boundary, at an angle with the advancement portion wall, seen in a diametrical cross-section of the channel,
such that seen in the axial aspiration direction an expansion of the channel is formed at the shoulder at each axial boundary, for pinning of a meniscus of the liquid portion at the respective axial boundary.

36. The device according to claim 31, wherein the device is a micropipette.

37. The device according to claim 31, wherein the portion of the liquid the device is suitable for, has a volume in the range below nanoliters, e.g. in the range of magnitude of 10² picoliters, 10¹ picoliters, 10⁰ picoliters, 10² femtolitres or 10¹ femtoliters, e.g. wherein an internal volume enclosed by one or more of the channel portions of the array and/or a channel portion between the array and the opening, is equal to this volume.

38. The device according to claim 31, wherein for each of at least three in the aspiration direction succeeding ones of the shoulders for meniscus pinning in that direction, the angle is larger than the angle at the in the aspiration direction preceding one of the shoulders, and/or
wherein for each of at least three in the dispension direction succeeding ones of the shoulders for meniscus pinning in that direction, the angle is larger than the angle at the in the dispension direction preceding one of the shoulders.

39. The device according to claim 31, wherein for each one of the shoulders for meniscus pinning in the aspiration direction and/or for each one of the shoulders for meniscus pinning in the dispension direction, the angle is different.

40. The device according to claim 39, wherein for each of the shoulders succeeding one another in the aspiration direction for meniscus pinning in that direction, the angle is larger than the angle at the in the aspiration direction preceding one of the shoulders,
and/or
wherein for each of the shoulders succeeding one another in the dispension direction for meniscus pinning in that direction, the angle is larger than the angle at the in the dispension direction preceding one of the shoulders.

41. The device according to claim 31, wherein in the aspiration direction, a set of multiple succeeding shoulders with increasingly larger angles for meniscus pinning in that direction, is followed by one or more further sets of multiple succeeding shoulders with increasingly larger angles for meniscus pinning in that direction, the angle of the in the aspiration direction most upstream shoulder of any such further set being smaller than the angle of the in that direction most downstream shoulder of the preceding set,
and/or
wherein in the dispension direction, a set of multiple succeeding shoulders with increasingly larger respective angles for meniscus pinning in that direction, is followed by one or more further sets of multiple succeeding shoulders with increasingly larger angles for meniscus pinning in that direction, the angle of the in the dispension direction most upstream shoulder of any such further set being smaller than the angle of the in that direction most downstream shoulder of the preceding set.

42. The device according to claim 38, wherein the angles at the succeeding shoulders with increasingly larger angles for meniscus pinning differ by increasingly larger amounts, e.g. to such an extent that the burst pressure increases proportionally with the number of these shoulders successively encountered in the aspiration and/or dispension direction(s).

43. The device according to claim 31, wherein the channel portions of the array are each axisymmetrical with respect to an axially extending center axis, e.g. the array of the channel portions being axisymmetrical with respect to the center axis along its entire axial extension.

44. The device according to claim 31, wherein the device is configured to form by at least a part thereof a probe, or a part thereof, of a microfluidic atomic force microscope, a tip of the probe at a free-swinging end thereof providing the opening and the channel extending along a length of the probe over which a deflection takes place during use of the probe.

45. A microfluidic atomic force microscope comprising a device according to claim 31, wherein the device is configured to form by at least a part thereof a probe, or a part thereof, of the microscope, a tip of the probe at a free-swinging end thereof providing the opening and the channel extending along a length of the probe over which a deflection takes place during use of the probe.

46. The device according to claim 34, wherein the device is a micropipette.

47. The device according to claim 34, wherein the portion of the liquid the device is suitable for, has a volume in the range below nanoliters, e.g. in the range of magnitude of 10² picoliters, 10¹ picoliters, 10⁰ picoliters, 10² femtolitres or 10¹ femtoliters, e.g. wherein an internal volume enclosed by one or more of the channel portions of the array and/or a channel portion between the array and the opening, is equal to this volume.

48. The device according to claim 34, wherein for each of at least three in the aspiration direction succeeding ones of the shoulders for meniscus pinning in that direction, the angle is larger than the angle at the in the aspiration direction preceding one of the shoulders,
and/or
wherein for each of at least three in the dispension direction succeeding ones of the shoulders for meniscus pinning in that direction, the angle is larger than the angle at the in the dispension direction preceding one of the shoulders.

49. The device according to claim 34, wherein for each one of the shoulders for meniscus pinning in the aspiration direction and/or for each one of the shoulders for meniscus pinning in the dispension direction, the angle is different.

50. The device according to claim 49,
wherein for each of the shoulders succeeding one another in the aspiration direction for meniscus pinning in that direction, the angle is larger than the angle at the in the aspiration direction preceding one of the shoulders,
and/or
wherein for each of the shoulders succeeding one another in the dispension direction for meniscus pinning in that direction, the angle is larger than the angle at the in the dispension direction preceding one of the shoulders.

51. The device according to claim 34, wherein in the aspiration direction, a set of multiple succeeding shoulders with increasingly larger angles for meniscus pinning in that direction, is followed by one or more further sets of multiple succeeding shoulders with increasingly larger angles for meniscus pinning in that direction, the angle of the in the aspiration direction most upstream shoulder of any such further set being smaller than the angle of the in that direction most downstream shoulder of the preceding set,
and/or
wherein in the dispension direction, a set of multiple succeeding shoulders with increasingly larger respective angles for meniscus pinning in that direction, is followed by one or more further sets of multiple succeeding shoulders with increasingly larger angles for meniscus pinning in that direction, the angle of the in the dispension direction most upstream shoulder of any such further set being smaller than the angle of the in that direction most downstream shoulder of the preceding set.

52. The device according to claim 48, wherein the angles at the succeeding shoulders with increasingly larger angles for meniscus pinning differ by increasingly larger amounts, e.g. to such an extent that the burst pressure increases proportionally with the number of these shoulders successively encountered in the aspiration and/or dispension direction(s).

53. The device according to claim 34, wherein the channel portions of the array are each axisymmetrical with respect to an axially extending center axis, e.g. the array of the channel portions being axisymmetrical with respect to the center axis along its entire axial extension.

54. The device according to claim 31, wherein the device is configured to form by at least a part thereof a probe, or a part thereof, of a microfluidic atomic force microscope, a tip of the probe at a free-swinging end thereof providing the opening and the channel extending along a length of the probe over

55. A microfluidic atomic force microscope comprising the device according to claim 31, wherein the device is configured to form by at least a part thereof a probe, or a part thereof, of the microscope, a tip of the probe at a free-swinging end thereof providing the opening and the channel extending along a length of the probe over which a deflection takes place during use of the probe.
